(19) United States
(12) Patent Application Publication
(10) Pub. No.: US 2008/0271630 A1
(43) Pub. Date: Nov. 6, 2008

(54) METHOD FOR HANDLING PRINTING PLATES

(75) Inventors: Norbert DYLLA, Stadtbergen (DE); Thomas Gsell, Dillingen (DE); Hans Wolf, Augsburg (DE); Thomas Boeck, Neusaess (DE); Anton Hamm, Neusaess (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/113,700

(22) Filed: May 1, 2008

(30) Foreign Application Priority Data
May 3, 2007 (DE) 10 2007 020 718.4

(51) Int. Cl. B41L 47/14

(52) U.S. Cl. 101/477

(57) ABSTRACT

A method for handling printing plates, namely for arranging printing plates in cassettes that are used as printing plate repositories during a printing plate change, is disclosed. Each printing plate is assigned a coding before, during or after imaging relating to a plate cylinder position of a printing couple at which the respective printing plate is used. Each imaged and coded printing plate is transported to the region of a cassette. In the region of each cassette, the coding of the printing plates is read out, and in doing so a check is made to see whether the printing plates are located at the correct cassette. If it is established that the printing plates are located at the correct cassette, a defined accommodation position in the cassette is released for each printing plate and the printing plate is positioned at this accommodation position within the cassette.

This application claims the priority of German Patent Document No. 10 2007 020 718.4, filed May 3, 2007, the disclosure of which is expressly incorporated by reference herein.

### BACKGROUND AND SUMMARY OF THE INVENTION

The invention relates to a method for handling printing plates on a web-fed printing press, namely for arranging printing plates in cassettes being used as printing plate repositories during a printing plate change.

To perform a printing plate change, printing plates must be handled in the region of a web-fed printing press. In this case, when executing a printing plate change it is important for every printing plate to be conveyed to the correct printing couple of the correct printing unit of a web-fed printing press, and for every printing plate to be clamped at the correct plate cylinder position on the plate cylinder within the correct printing couple. In the case of web-fed printing presses in which the printing plates are changed manually, the printing plates are readied for operation manually by a printer at the plate cylinder positions of the printing couples of the printing units of a web-fed printing press. In the case of a printing press in which the printing plates are changed in an automated manner, the printing plates are supplied to the plate cylinder positions of the printing couples of the printing units of a web-fed printing press by means of cassettes, which are used as the printing plate repositories. The printing plates being kept in readiness in the cassettes can be removed automatically from the cassettes by means of a manipulator arm and conveyed automatically to the plate cylinders of the printing couples.

It is possible both in the case of web-fed printing presses where the printing plates are changed manually as well as in the case of web-fed printing presses where the printing plates are changed automatically for incorrect assignments to occur during a printing plate change, i.e., printing plates can be conveyed to the wrong printing couples or to the wrong plate cylinder positions on a printing couple.

In the case of a manual printing plate change, this incorrect assignment can come about by a printer providing a printing plate at a wrong printing couple or at a wrong plate cylinder position for the printing plate change. In the case of an automatic printing plate change, this sort of incorrect assignment can be caused by printing plates being readied for operation in the wrong cassettes or at the wrong accommodation positions within a cassette.

Starting herefrom, the present invention is based on the objective of creating a novel method for handling printing plates. According to an embodiment of the invention, the method includes: a) each printing plate is assigned a coding before, during or after imaging relating to the plate cylinder position of the printing couple of the printing unit of a web-fed printing press at which the respective printing plate is used; b) each imaged and coded printing plate is transported to the region of a cassette, wherein each cassette is used to accommodate several printing plates and, consequently, several printing plates are transported to the region of each cassette; c) in the region of each cassette, the coding of the printing plates, which are located in the region of the respective cassette, is read out, and in doing so a check is made to see whether the printing plates are located at the correct cassette, and wherein if it is established during this process that the printing plates are located at the correct cassette, a defined accommodation position in the cassette is released for each printing plate and the printing plate is positioned at this accommodation position within the cassette.

The inventive method makes it possible to assure that printing plates for executing an automated printing plate change are kept in readiness in the correct cassettes as well as at the correct accommodation positions within the cassettes, which are used as printing plate repositories. The arrangement of the printing plates in the cassettes is biunique so that incorrect assignments of printing plates to the plate cylinders can be reduced to the absolute minimum.

Preferred developments of the invention are yielded from the following description. Without being limited hereto, exemplary embodiments of the invention are explained in greater detail in the following.

### DETAILED DESCRIPTION OF EXEMPLARY EMBODIMENTS

The present invention relates to a method for handling printing plates on a web-fed printing press, namely for arranging printing plates in cassettes that are used as printing plate repositories during an automated printing plate change.

Within the scope of the present invention, each printing plate is provided with a coding that unambiguously identifies the plate cylinder position of the printing couple of the printing unit of a web-fed printing press at which the respective printing plate is used. The coding is assigned to each printing plate before, during or after imaging. The coding contains unambiguous information about the target location of the printing plate.

The coding assigned to each printing plate can be designed as an optically readable barcode or text code. Moreover, it is also possible for each printing plate to be assigned a coding stored in a non-contact readable RFID tag. Furthermore, it is possible to provide each printing plate with a mechanically readable coding, wherein this type of mechanically readable coding is preferably designed as notching of the printing plate.

Each imaged and coded printing plate is then transported to the region of a cassette. Each cassette is used to accommodate several printing plates and, consequently, several printing plates are transported to the region of each cassette.

To transport the printing plate in the direction of the cassettes, the coding is preferably read out, in order to control transport of the printing plates to the region of the cassettes as a function of the coding. However, it is also possible as an alternative to transport the printing plates to the region of the cassettes without the information contained in the coding.

After transport of the printing plates to the region of the respective cassette, in the region of each cassette, the coding of the printing plates, which are located in the region of the respective cassette, is read out. Reading out the coding occurs as a function of the coding, e.g., optically, via radio waves, or mechanically.

When the coding of the printing plates is read out, a check is made to see whether the printing plates are located at the correct cassette. If it is established that a printing plate is located at the wrong cassette, an error message is generated. If, on the other hand, it is established that a printing plate is located at the correct cassette, a defined accommodation position in the cassette is then released for the respective printing plate and the printing plate is positioned at this, or in this, accommodation position within the cassette.

All printing plates transported to the region of a cassette are handled sequentially, i.e., one after the other, in terms of reading out the coding, checking the coding, releasing the accommodation positions as well as positioning the printing plates in the respective accommodation position. Only when the handling of a printing plate is concluded, does the handling of another printing plate begin. Consequently, the printing plates are inserted into the corresponding accommodation positions of the respective cassettes in succession.

The accommodation positions of the cassettes are preferably released in that a flap or a locking bar assigned to the respective accommodation position is released.

A printing plate cannot be inserted into an accommodation position of a cassette until after the flap or locking bar has been released on the basis of reading out the coding of a printing plate.

The insertion of the printing plates into the accommodation positions of the cassettes is monitored in order to hereby establish that a printing plate has actually reached the correct accommodation position and is completely inserted in the accommodation position. If it should be established in the process that a printing plate has reached the wrong accommodation position, or a printing plate is not completely inserted into the accommodation position, an error message is preferably generated.

When the printing plates are being inserted into the accommodation positions of the cassettes, the printing plates can also be checked for damage in order to assure that only undamaged printing plates reach the cassettes and are used for the printing plate change. Furthermore, when the printing plates are being inserted into the accommodation positions of the cassettes, they can also be monitored to make sure that they are oriented correctly, i.e., the printing plate has not reached the accommodation position of a cassette with either the leading and trailing edges of the printing plate being transposed or the front and reverse sides of the printing plate being transposed.

All steps of the inventive method can be performed automatically. As a result, the coding can be applied automatically to the printing plates. In addition, transport of the printing plates to the cassettes can be performed automatically. Furthermore, reading the coding of the printing plates in the region of the cassettes, checking the coding as well as releasing the accommodation positions and inserting the printing plates into the accommodation positions of the cassettes can be performed automatically. As a result, it is possible to rule out the incorrect assignment of printing plates due to incorrect manual operations during printing plate changes.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for handling a printing plate, comprising the steps of:
a) assigning the printing plate a coding before, during or after imaging relating to a plate cylinder position of a printing couple of a printing unit of a web-fed printing press at which the printing plate is to be used;
b) transporting the imaged and coded printing plate to a region of a cassette, wherein the cassette is used to accommodate several printing plates; and
c) in the region of the cassette, the coding of the printing plate is read out to check whether the printing plate is located at a correct cassette, and wherein if it is established during this check that the printing plate is located at the correct cassette, a defined accommodation position in the cassette is released for the printing plate and the printing plate is positioned at this accommodation position within the cassette.

2. A method for handling a printing plate, comprising the steps of:
a) assignment of a position in a cassette to a position on a plate cylinder in a web-fed rotary press;
b) marking of a printing plate to be installed at the position on the plate cylinder with information related to the position in the cassette;
c) transporting the printing plate to the cassette; and
d) verifying a correct association between the printing plate and the position in the cassette based on the marking on the printing plate.

3. The method according to claim 1, wherein in step a) the printing plate is assigned an optically readable barcode or text code as the coding.

4. The method according to claim 1, wherein in step a) the coding is stored in a non-contact readable RFID tag.

5. The method according to claim 1, wherein in step a) the coding is a mechanically readable coding.

6. The method according to claim 1, wherein in step a) the coding is automatically assigned to the printing plate.

7. The method according claim 1, wherein in step b) the printing plate is automatically transported to the region of the cassette.

8. The method according to claim 7, wherein for transport, the coding of the printing plate is read out and, as a function of the coding, the printing plate is transported to the region of the cassette.

9. The method according to claim 1, wherein the steps of reading out the coding, checking, releasing the accommodation position, and positioning the printing plate in the accommodation position are performed automatically.

10. The method according to claim 1, wherein if it is established in step c) that the printing plate is located at an incorrect cassette, an error message is generated.

11. The method according to claim 1, wherein in step c), in the region of the cassette, the printing plate is handled in succession in terms of reading out the coding, checking, releasing the accommodation position, and positioning the printing plate in the accommodation position with respect to other printing plates to be positioned within the cassette.

12. The method according to claim 2, wherein the printing plate is assigned an optically readable barcode or text code as the marking.

13. The method according to claim 2, wherein the marking is stored in a non-contact readable RFID tag.

14. The method according to claim 2, wherein the marking is a mechanically readable coding.

15. The method according to claim 2, wherein the marking is automatically assigned to the printing plate.

16. The method according claim 2, wherein the printing plate is automatically transported to the cassette.

17. The method according to claim 16, wherein for transport, the marking of the printing plate is read out and, as a function of the marking, the printing plate is transported to the cassette.

18. The method according to claim 2, wherein the verifying step is performed automatically.

19. The method according to claim 2, wherein if it is established in step d) that the printing plate is located at an incorrect cassette, an error message is generated.

20. The method according to claim 2, wherein the printing plate is handled in succession in terms of the step of verifying with respect to other printing plates to be positioned within the cassette.
